(19) United States
(12) Patent Application Publication
(10) Pub. No.: US 2012/0227309 A1
(43) Pub. Date: Sep. 13, 2012

(54) FISHING ROD AND REEL CARRYING CASE

(76) Inventor: STEPHEN A. FANELLI, West Chester, PA (US)

(21) Appl. No.: 13/411,077

(22) Filed: Mar. 2, 2012

Related U.S. Application Data
(60) Provisional application No. 61/450,943, filed on Mar. 9, 2011.

(51) Int. Cl. A01K 97/08

(52) U.S. Cl. 43/26

(57) ABSTRACT

The fishing rod and reel carrying case is designed to house a fully assembled rod and reel for transport and temporary storage thereof. The case is of an elongate configuration and incorporates a zipper or the like for closing and opening the case. The case incorporates handles to enhance transport thereof. The case is fabricated from a composite material that provides protection from damage for the encased rod and reel, and also provides for buoyancy should the case fall into the water.

### CROSS-REFERENCE TO RELATED APPLICATION

This application claims the benefit of U.S. Provisional patent application Ser. No. 61/450,943, filed Mar. 9, 2011.

### BACKGROUND OF THE INVENTION

1. Field of the Invention

The present invention generally relates to cases for transporting and storing articles, and particularly to a fishing rod and reel carrying case.

2. Description of the Related Art

Transporting and adequately protecting fishing equipment, especially a rod and reel, is awkward because of the slender, elongate configuration of the rod and the relative bulkiness of the reel attached adjacent the butt end of the rod. To avoid damage, some fishermen prefer to remove the reel and fishing line from the rod, take the rod apart, and store the various parts in tubes. This scenario is time-consuming because the equipment must be reassembled after each portage. Although various cases for storing and carrying fishing rods have been proposed, none has proven to be entirely satisfactory. The industry would certainly welcome a carrying case that would house a fully assembled rod and reel and afford adequate protection from damage and ambient elements when the rod and reel are being transported or temporarily stored. Thus a fishing rod and reel carrying case solving the aforementioned problems is desired.

### SUMMARY OF THE INVENTION

The fishing rod and reel carrying case is designed to house a fully assembled rod and reel for transport and temporary storage thereof. The case is of an elongate configuration and incorporates a zipper or the like for closing and opening the case. The case incorporates handles to enhance transporting thereof. The case is fabricated from a composite material that provides protection from damage for the encased rod and reel and also provides buoyancy should the case fall into the water.

Accordingly, the invention presents a case for housing an assembled rod and reel, the case being made from materials that provide protection to the rod and reel from damage due to rough handling and exposure to the elements. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a first embodiment of a fishing rod and reel carrying case according to the present invention.

FIG. 2 is an environmental perspective view of the fishing rod and reel carrying case of FIG. 1, shown fully open and housing a rod and reel.

FIG. 3 is a perspective view of the fishing rod and reel carrying case of FIG. 1, shown fully open but without the rod and reel.

FIG. 4 is a partial perspective view of the fishing rod and reel carrying case of FIG. 1, showing details of a flap for protecting the zipper sliders for opening and closing the case.

FIG. 5 is a partial environmental perspective view of the fishing rod and reel carrying case of FIG. 1, showing the case partially open.

FIG. 6 is a partial perspective view of a second embodiment of a fishing rod and reel carrying case according to the present invention.

Similar reference characters denote corresponding features consistently throughout the attached drawings.

### DETAILED DESCRIPTION OF THE PREFERRED EMBODIMENTS

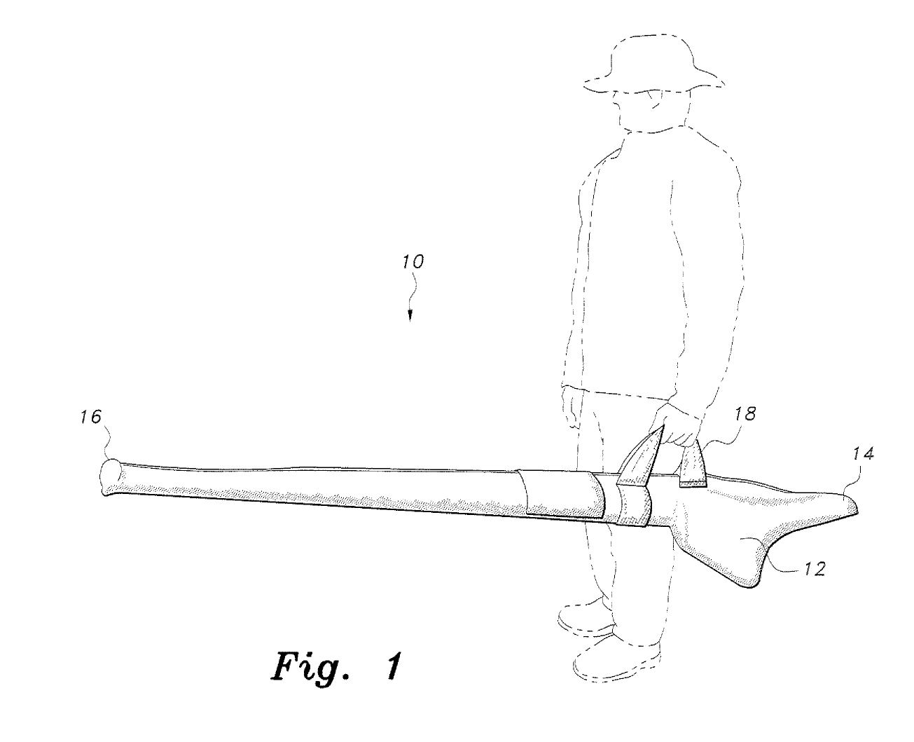

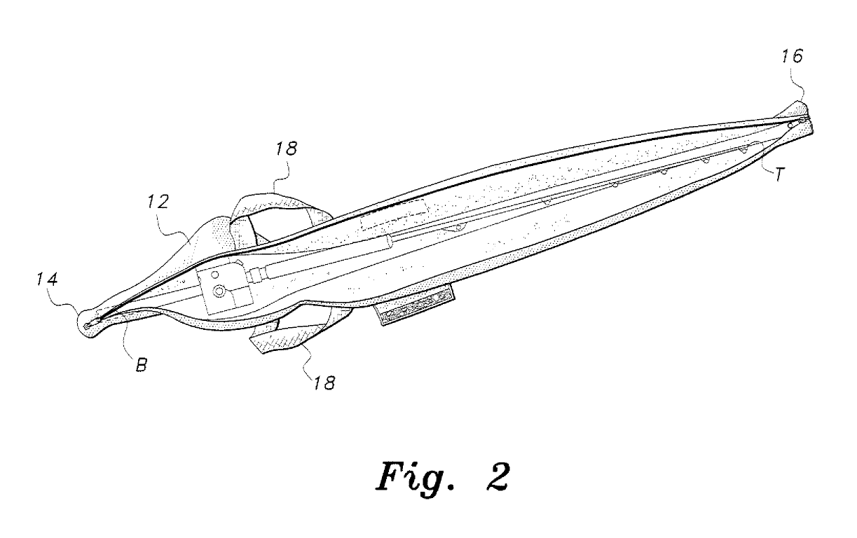

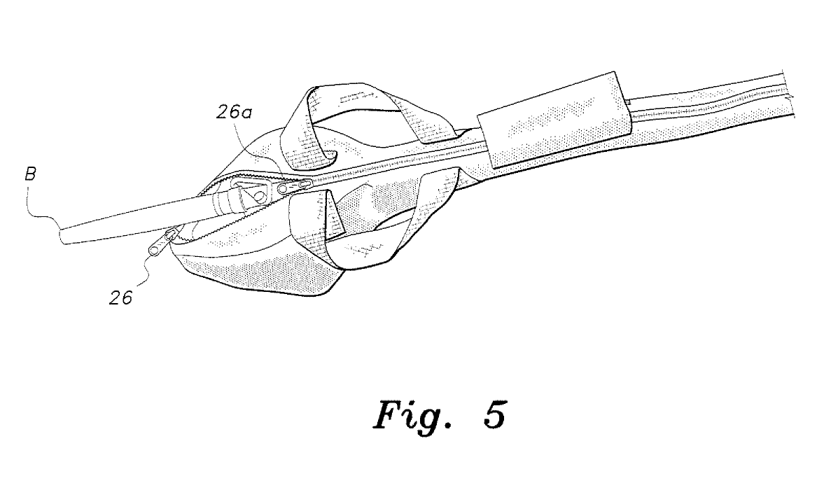

Referring to FIGS. 1 through 5, the fishing rod and reel carrying case 10 is of an elongate configuration and, as indicated above, is designed to house and protect an assembled fishing rod and reel therein. An enlarged pouch-like portion 12 is provided adjacent a proximate end 14, the pouch-like portion 12 encasing the butt of the rod. The pouch 12 is dimensioned and configured to house the reel therein. The case 10 terminates in a distal end 16 that houses the tip end T of the rod. Carrying handles 18 are disposed closely adjacent the pouch-like portion 12 and between the pouch-like portion 12 and the distal end 16 to facilitate portability. The handles 18 are positioned to achieve balance when the case 10 is carried.

The case 10 comprises a rugged outer layer 20 fabricated from a heavy canvas, nylon, or similar woven material. The inner layer 22 is fabricated from a suitable, relatively soft and pliable non-woven material. The combination of materials presents a case 10 that is rugged enough to provide protection to the rod and reel when subjected to rough handling. The materials both protect the rod and reel from the elements and function to provide buoyancy to prevent the case 10 (and the enclosed rod and reel) from sinking if it falls in the water. The inner layer is contoured at 24 to form a stabilizing position for the rod.

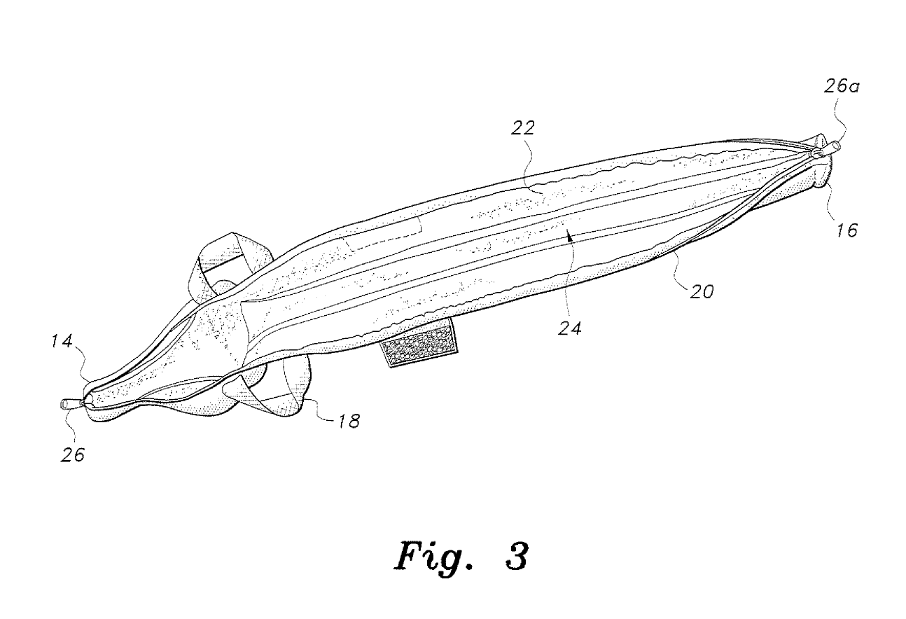

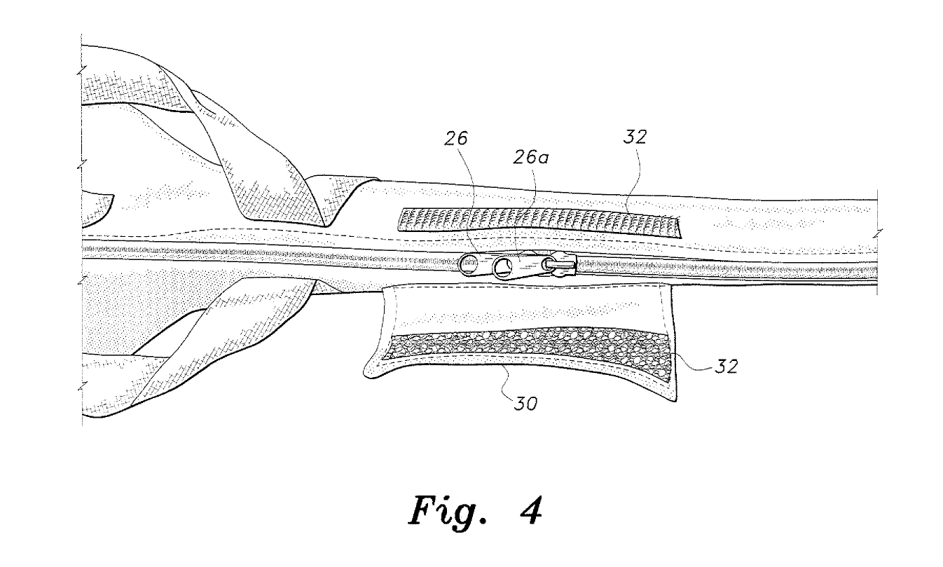

A pair of closure members 26, 26a (preferably sliders for a zipper) allow three operative positions for the case. In a fully closed position the sliders abut each other, as shown in FIG. 4. In a fully open position, each respective slider is disposed at an opposite end of the case, as shown in FIG. 3. In a partially open position, one slider 26 is spaced apart from the other slider 26a to allow the butt B of the rod to be exposed. This allows the butt B to be inserted into a rod holder of a boat without removing the entire rod from the case 10 until desired.

As best seen in FIG. 4, a flap 30 is employed to cover the sliders 26, 26a when the case is fully closed. Mating hook and loop fasteners 32 or the like are utilized to secure the flap 30. A lock (not shown) may be employed to fasten the sliders 26, 26a in the closed position.

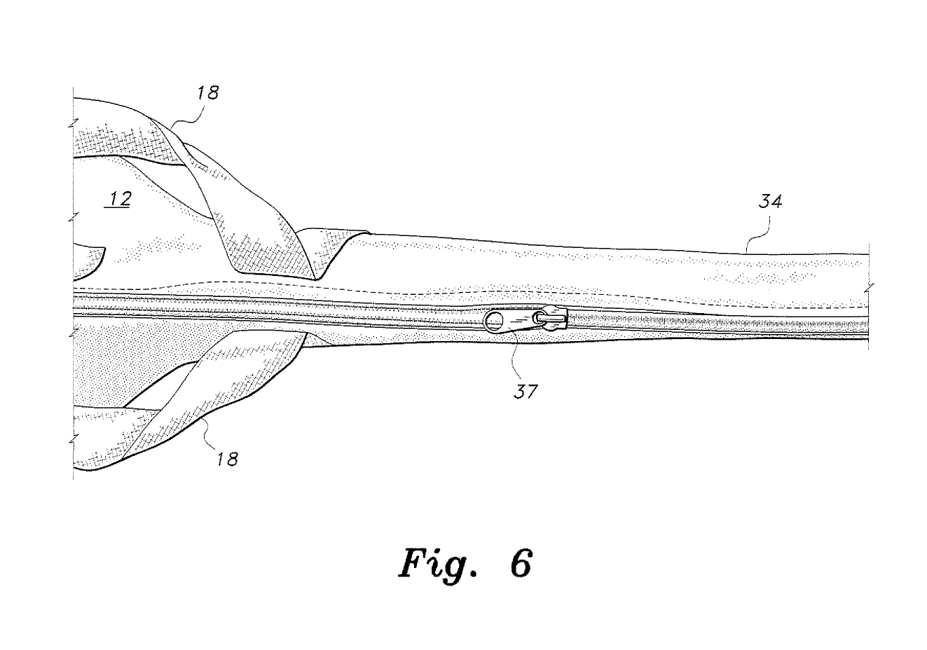

The embodiment of FIG. 6 is similar to the embodiment described above, but employs only a single slider 37 for closing or opening the case 10 and no protective flap is utilized to cover the slider. Also, the outer material 34 is of a lighter weight than the material of the first embodiment. The second embodiment presents a less expensive model than the first embodiment.

It is to be understood that the present invention is not limited to the embodiments described above, but encompasses any and all embodiments within the scope of the following claims.

I claim:

1. A carrying case for a rod and reel, comprising:
an elongate housing having a proximate end and a distal end, the housing having an enlarged pouch portion at the proximate end, the housing being adapted for enclosing a fishing rod, the pouch portion being configured for enclosing a reel attached to the rod;
carrying handles attached to the housing, the carrying handles being positioned adjacent the pouch; and
a closure member for optionally opening and closing the elongate housing, the closure member extending from the proximate end to the distal end.

2. The carrying case according to claim 1, wherein said carrying handles are positioned between said pouch and the distal end.

3. The carrying case according to claim 1, wherein said case includes an outer layer fabricated from a relatively heavy, woven, composite material.

4. The carrying case according to claim 1, wherein said case includes an outer layer fabricated from a relatively lightweight, woven, composite material.

5. The carrying case according to claim 1, wherein said case includes an inner layer fabricated from a relatively soft and pliable non-woven material.

6. The carrying case according to claim 1, wherein said closure member comprises a zipper having a pair of sliders for optionally opening and closing said closure member.

7. A carrying case for a rod and reel, comprising:
an elongate housing having a proximate end and a distal end, the housing having an enlarged pouch portion at the proximate end, the housing being adapted for enclosing a fishing rod, the pouch portion being configured for enclosing a reel attached to the rod;
carrying handles attached to the housing, the carrying handles being positioned adjacent the pouch between the pouch and the distal end; and
a closure member for optionally opening and closing the elongate housing, the closure member being a zipper extending from the proximate end to the distal end.

8. The carrying case according to claim 7, wherein said case includes an outer layer fabricated from a relatively heavy, woven, composite material.

9. The carrying case according to claim 7, wherein said case includes an outer layer fabricated from a relatively lightweight, woven, composite material.

10. The carrying case according to claim 7, wherein said case includes an inner layer fabricated from a relatively soft and pliable non-woven material.

11. The carrying case according to claim 7, wherein said zipper has a pair of sliders for optionally opening and closing said closure member.

12. The carrying case according to claim 11, further including a flap mounted on said carrying case to optionally cover the pair of sliders when the carrying case is fully closed.

13. A carrying case for a rod and reel, comprising:
an elongate housing having a proximate end and a distal end, the housing having an enlarged pouch portion at the proximate end, the housing being adapted for enclosing a fishing rod, the pouch portion being configured for enclosing a reel attached to the rod;
carrying handles attached to the housing, the carrying handles being positioned adjacent the pouch between the pouch and the distal end; and
a closure member for optionally opening and closing the elongate housing, the closure member being a zipper extending from the proximate end to the distal end, the zipper having at least one slider member.

14. The carrying case according to claim 13, wherein said case includes an inner layer fabricated from a contoured, relatively soft and pliable non-woven material.

15. The carrying case according to claim 14, wherein said case includes an outer layer fabricated from a relatively lightweight, woven, composite material.

16. The carrying case according to claim 14, wherein said case includes an outer layer fabricated from a relatively heavy, woven, composite material

17. The carrying case according to claim 13, wherein said at least one slider comprises a pair of sliders for optionally opening and closing said closure member.

18. The carrying case according to claim 17, further including a flap mounted on said carrying case to optionally cover the pair of sliders when the carrying case is fully closed.
